(19) United States
(12) Patent Application Publication
(10) Pub. No.: US 2010/0068395 A1
(43) Pub. Date: Mar. 18, 2010

(54) METHOD OF PRODUCING CERAMIC SPRAY-COATED MEMBER, PROGRAM FOR CONDUCTING THE METHOD, STORAGE MEDIUM AND CERAMIC SPRAY-COATED MEMBER

(75) Inventors: Tsuyoshi MORIYA, Yamanashi (JP); Hiroyuki NAKAYAMA, Yamanashi (JP); Hiroshi NAGAIKE, Yamanashi (JP); Keigo KOBAYASHI, Chiba (JP); Kaname YASUDA, Yamanashi (JP)

Correspondence Address: GREENBLUM & BERNSTEIN, P.L.C., 1950 ROLAND CLARKE PLACE, RESTON, VA, 20191, US

(73) Assignee: TOKYO ELECTRON LIMITED, Tokyo (JP)

(21) Appl. No.: 12/499,588

(22) Filed: Jul. 8, 2009

Related U.S. Application Data
(62) Division of application No. 11/266,355, filed on Nov. 4, 2005, now abandoned.

(30) Foreign Application Priority Data
Nov. 8, 2004 (JP) 2004-323545

(51) Int. Cl. B05D 3/10; B05C 11/00

(52) U.S. Cl. 427/343; 427/337; 118/696

(57) ABSTRACT

A ceramic spray-coated member capable of surely controlling adhesion and detachment of water is produced by spraying a given ceramic onto a surface of a base material, in which an organic matter adsorbed on a surface of the ceramic spray-coated member is removed and the surface of the ceramic spray-coated member is stabilized by chemically bonding to water.

### CROSS-REFERENCE TO RELATED APPLICATIONS

This application is a divisional of U.S. patent application Ser. No. 11/266,355, filed Nov. 4; 2005, the contents of which are expressly incorporated by reference herein in their entirety, which claims priority to Japanese Application No. 2004-323545, filed Nov. 8, 2004.

### BACKGROUND OF THE INVENTION

1. Field of the Invention

This invention relates to a method of producing a ceramic spray-coated member, a program for conducting this method, a storage medium, and a ceramic spray-coated member, and more particularly to a ceramic spray-coated member such as transport arm or the like used in a transport device transporting an electrode, a focus ring, a electrostatic chuck or the like used in a chamber formed with a treating gas filled plasma atmosphere and a substrate or the like into a process apparatus, a method of producing a ceramic spray-coated member, a program for conducting this method, and a storage medium housing the program.

2. Related Art

Heretofore, a member spray-coated with a ceramic such as yttrium oxide (Y₂O₃) (yttria), aluminum oxide (Al₂O₃) or the like is used in an interior of a process apparatus having a substrate housing room, for example, a chamber. In general, the ceramic tends to be high in the reactivity with water content in air, so that there is a possibility that when the interior of the chamber is opened in air in the periodic check or when the wet cleaning is carried out in the interior of the chamber, a great amount of water adheres to the ceramic spray-coated member such as inner wall of the chamber, upper electrode or the like.

As a result, there are inconveniences resulted from the detachment or adhesion of water to the inner wall of the chamber, for example, problems of causing the lowering of operation rate in the process apparatus due to the prolongation of vacuum arriving time in the chamber, abnormality of forming the film in the formation of the metal film, the instability of the etching rate in the etching of the oxide film or the like, the occurrence of particles peeled in the plasma formation, the occurrence of abnormal discharge and so on.

In order to solve the above problems, JPA-2004-190136 discloses a technique wherein a member spray-coated with a given ceramic (hereinafter referred to as a ceramic spray-coated member) is immersed in a boiling water for a long time or subjected to a heat treatment under an environment of high temperature, high pressure and high humidity, whereby the ceramic is hydrated with water to conduct the hydration treatment of the ceramic surface. According to this technique, the hydrophobicity of the ceramic surface in the ceramic spray-coated member is improved, whereby it is made possibility to reduce the adhesion of water to the ceramic spray-coated member.

However, if the organic matter or the like included in the atmosphere adheres to the ceramic surface in the ceramic spray-coated member, the activated state of the ceramic surface is deteriorated. As a result, when the hydration treatment is applied to the ceramic spray-coated member, the hydration reaction is obstructed on the ceramic surface and the hydrophobicity of the ceramic surface is not obtained sufficiently, and hence there is a problem that the adhesion or detachment of water in the ceramic spray-coated member can not be controlled surely.

### SUMMARY OF THE INVENTION

It is, therefore, an object of the invention to provide a production method of a ceramic spray-coated member capable of surely controlling the adhesion and detachment of water, a program for conducting such a method, a storage medium and a ceramic spray-coated member.

In order to achieve the above object, claim 1 of the invention lies in a method of producing a ceramic spray-coated member by spraying a given ceramic onto a surface of a base material, which comprises the steps of removing an organic matter adsorbed on a surface of the ceramic spray-coated member and chemically bonding the surface of the ceramic spray-coated member to water to conduct stabilization thereof.

In the method according to claim 1, claim 2 is characterized in that the removing step is conducted by immersing the ceramic spray-coated member in an organic solvent.

In the method according to claim 2, claim 3 is characterized in that the organic solvent includes at least one of acetone, ethyl alcohol, methyl alcohol, butyl alcohol and isopropyl alcohol.

In the method according to claim 1, claim 4 is characterized in that the removing step is conducted by immersing the ceramic spray-coated member in an acid.

In the method according to claim 4, claim 5 is characterized in that the acid includes at least one of hydrofluoric acid, nitric acid, hydrochloric acid, sulfuric acid and acetic acid.

In the method according to any one of claims 1 to 5, claim 6 is characterized in that the organic matter has a hydrocarbon group containing at least CH group.

In the method according to any one of claims 1 to 6, claim 7 is characterized in that the ceramic is made of a rare earth metal oxide.

In the method according to claim 7, claim 8 is characterized in that the rare earth metal oxide is yttria.

In the method according to any one of claims 1 to 8, claim 9 is characterized in that the ceramic spray-coated member is used in a chamber for treating a substrate.

In order to achieve the above object, claim 10 is a method of producing a ceramic spray-coated member by spraying a given ceramic onto a surface of a base material, which comprises the steps of preventing adsorption of an organic matter onto a surface of the ceramic spray-coated member and chemically bonding the surface of the ceramic spray-coated member to water to conduct stabilization thereof.

In the method according to claim 10, claim 11 is characterized in that the adsorption preventing step is conducted by storing the ceramic spray-coated member in a flow of a gas passed through a chemical filter.

In the method according to claim 9 or 10, claim 12 is characterized in that the organic matter has a hydrocarbon group containing at least CH group.

In the method according to any one of claims 9 to 11, claim 13 is characterized in that the ceramic is made of a rare earth metal oxide.

In the method according to claim 13, claim 14 is characterized in that the rare earth metal oxide is yttria.

In the method according to any one of claims 10 to 14, claim 15 is characterized in that the ceramic spray-coated member is used in a chamber for treating a substrate.

In order to achieve the above object, claim 16 is a ceramic spray-coated member by spraying a given ceramic as a surface layer, characterized in that a compound having a hydroxyl group is existent on the surface layer of the ceramic spray-coated member and an organic matter is removed from the surface of the surface layer.

In the ceramic spray-coated member according to claim 16, claim 17 is characterized in that the compound having a hydroxyl group is a hydroxide of the given ceramic.

In the ceramic spray-coated member according to claim 16 or 17, claim 18 is characterized in that the organic matter has a hydrocarbon group having at least CH group.

In the ceramic spray-coated member according to any one of claims 16 to 18, claim 19 is characterized in that the ceramic is a rare earth metal oxide.

In the ceramic spray-coated member according to claim 19, claim 20 is characterized in that the rare earth metal oxide is yttria.

In the ceramic spray-coated member according to anyone of claims 16 to 20, claim 21 is characterized in that the ceramic spray-coated member is used in a chamber for treating a substrate.

In order to achieve the above object, claim 22 is a readable program for conducting a method of producing a ceramic spray-coated member by spraying a given ceramic on a surface with a computer, characterized in that the program has a removal module for removing an organic matter adsorbed on the surface of the ceramic spray-coated member and a stabilization module for chemically bonding the surface of the ceramic spray-coated member to water to conduct stabilization.

In the program according to claim 22, claim 23 is characterized in that the removal module is an immersion of the ceramic spray-coated member in an organic solvent.

In the program according to claim 22, claim 24 is characterized in that the removal module is the immersion of the ceramic spray-coated member in an acid.

In order to achieve the above object, claim 25 is a readable program for conducting a method of producing a ceramic spray-coated member by spraying a given ceramic on a surface with a computer, characterized in that the program has an adsorption preventing module for preventing adsorption of an organic matter on the surface of the ceramic spray-coated member and a stabilization module for chemically bonding the surface of the ceramic spray-coated member to water to conduct stabilization.

In the program according to claim 25, claim 26 is characterized in that the adsorption preventing module is the storage of the ceramic spray-coated member in a flow of a gas passed through a chemical filter.

In order to achieve the above object, claim 27 is a storage medium for housing a readable program for conducting a method of producing a ceramic spray-coated member by spraying a given ceramic on a surface with a computer, characterized in that the program has a removal module for removing an organic matter adsorbed on the surface of the ceramic spray-coated member and a stabilization module for chemically bonding the surface of the ceramic spray-coated member to water to conduct stabilization.

In the storage medium according to claim 27, claim 28 is characterized in that the removal module is an immersion of the ceramic spray-coated member in an organic solvent.

In the storage medium according to claim 27, claim 29 is characterized in that the removal module is the immersion of the ceramic spray-coated member in an acid.

In order to achieve the above object, claim 30 is a storage medium for housing a readable program for conducting a method of producing a ceramic spray-coated member by spraying a given ceramic on a surface with a computer, characterized in that the program has an adsorption preventing module for preventing adsorption of an organic matter on the surface of the ceramic spray-coated member and a stabilization module for chemically bonding the surface of the ceramic spray-coated member to water to conduct stabilization.

In the storage medium according to claim 30, claim 31 is characterized in that the adsorption preventing module is the storage of the ceramic spray-coated member in a flow of a gas passed through a chemical filter.

According to the method of producing a ceramic spray-coated member in claim 1 and the program in claim 22 and the storage medium in claim 27, the organic matter adsorbed on the surface of the ceramic spray-coated member is removed and the surface of the ceramic spray-coated member is stabilized by chemically bonding to water, so that when the ceramic spray-coated member is subjected to a hydration treatment, the hydration reaction on the ceramic surface is promoted, whereby the hydrophobicity on the ceramic surface can be sufficiently obtained and hence the adhesion and detachment of water in the ceramic spray-coated member can be surely controlled.

According to the method of producing a ceramic spray-coated member in claim 2 and the program in claim 23 and the storage medium in claim 28, the ceramic spray-coated member is immersed in the organic solvent, so that the organic matter resulting in the obstruction of the hydration reaction on the ceramic surface is dissolved out into the organic solvent, whereby the organic matter adsorbed on the surface of the ceramic spray-coated member can be removed surely.

According to the method of producing a ceramic spray-coated member in claim 3, the organic solvent includes at least one of acetone, ethyl alcohol, methyl alcohol, butyl alcohol and isobutyl alcohol, so that the organic matter adsorbed on the surface of the ceramic spray-coated member can be removed further surely.

According to the method of producing a ceramic spray-coated member in claim 4 and the program in claim 24 and the storage medium in claim 29, the ceramic spray-coated member is immersed in the acid, whereby the surface of the ceramic spray-coated member adsorbed with the organic matter is etched and hence the organic matter adsorbed on the surface of the ceramic spray-coated member can be removed surely.

According to the method of producing a ceramic spray-coated member in claim 5, the acid includes at least one of hydrofluoric acid, nitric acid, hydrochloric acid, sulfuric acid and acetic acid, so that the organic matter adsorbed on the surface of the ceramic spray-coated member can be removed further surely.

According to the method of producing a ceramic spray-coated member in claim 6, the organic matter to be removed has a hydrocarbon group having at least CH group, so that the hydrocarbon group mainly causing the obstruction of the hydration reaction at the ceramic surface can be removed surely.

According to the method of producing a ceramic spray-coated member in claim 7, the ceramic is made of a rare earth metal oxide, so that there can be controlled the erosion of the ceramic spray-coated member under a strong corrosion environment.

According to the method of producing a ceramic spray-coated member in claim 8, the rare earth metal oxide is yttria, so that there can be further controlled the erosion of the ceramic spray-coated member under a strong corrosion environment.

According to the method of producing a ceramic spray-coated member in claim 9, the ceramic spray-coated member stably bonding water chemically adsorbed on the surface is used in a chamber for treating the substrate, so that there can be prevented the occurrence of inconvenience resulted from the detachment of water adhered to the inner wall of the chamber.

According to the method of producing a ceramic spray-coated member in claim 10 and the program in claim 25 and the storage medium in claim 30, the adsorption of the organic matter onto the surface of the ceramic spray-coated member is prevented and the surface of the ceramic spray-coated member is stabilized by chemically bonding to water, so that the hydration reaction at the ceramic surface is promoted when the ceramic spray-coated member is subjected to the hydration treatment, whereby the hydrophobicity at the ceramic surface can be sufficiently obtained and hence the adhesion and detachment of water in the ceramic spray-coated member can be controlled surely.

According to the method of producing a ceramic spray-coated member in claim 11 and the program in claim 26 and the storage medium in claim 31, the ceramic spray-coated member is stored in the flow of the gas passed through the chemical filter, whereby the ceramic spray-coated member can be prevented to be exposed to an atmosphere containing the organic matter and hence it can be prevented to adhere the organic matter to the surface of the ceramic spray-coated member.

According to the method of producing a ceramic spray-coated member in claim 12, the organic matter to be removed has a hydrocarbon group having at least CH group, so that the hydrocarbon group mainly causing the obstruction of the hydration reaction at the ceramic surface can be surely removed.

According to the method of producing a ceramic spray-coated member in claim 13, the ceramic is made of a rare earth metal oxide, so that it can be controlled to erode the ceramic spray-coated member under a strong corrosion environment.

According to the method of producing a ceramic spray-coated member in claim 14, the rare earth metal oxide is yttria, so that it can be further controlled to erode the ceramic spray-coated member under the strong corrosion environment.

According to the method of producing a ceramic spray-coated member in claim 15, the ceramic spray-coated member stably bonding water chemically adsorbed on the surface is used in a chamber for treating the substrate, so that there can be prevented the occurrence of inconvenience resulted from the detachment of water adhered to the inner wall of the chamber.

According to the ceramic spray-coated member in claim 16, the compound having hydroxyl group is existent on the surface layer of the ceramic spray-coated member and the organic matter is removed from the surface of the surface layer. The water chemically adsorbed on the surface layer of the ceramic spray-coated member is stabilized by the hydration treatment but the hydration reaction is promoted in the surface layer removing the organic matter, so that the hydrophobicity at the ceramic surface can be sufficiently obtained when the organic matter is removed from the surface of the surface layer, whereby the adhesion and detachment of water in the ceramic spray-coated member can be surely controlled.

According to the ceramic spray-coated member in claim 17, the compound having hydroxyl group is a hydroxide of the given ceramic, so that the detachment and adhesion of water in the ceramic spray-coated member can be controlled further surely.

According to the ceramic spray-coated member in claim 18, the organic matter to be removed has a hydrocarbon group having at least CH group, so that the hydrocarbon group mainly causing the obstruction of the hydration reaction at the ceramic surface can be surely removed.

According to the ceramic spray-coated member in claim 19, the ceramic is made of a rare earth metal oxide, so that the ceramic spray-coated member can be controlled to be eroded under a strong corrosion environment.

According to the ceramic spray-coated member in claim 20, the rare earth metal oxide is yttria, so that it can be further controlled to erode the ceramic spray-coated member under the strong corrosion environment.

According to the ceramic spray-coated member in claim 21, the ceramic spray-coated member stably bonding water chemically adsorbed on the surface is used in a chamber for treating the substrate, so that there can be prevented the occurrence of inconvenience resulted from the detachment of water adhered to the inner wall of the chamber.

### BRIEF DESCRIPTION OF THE DRAWINGS

The invention will be described with reference to the accompanying drawings, wherein:

FIG. 1 is a schematically section view of a plasma treating apparatus using a ceramic spray-coated member according to an embodiment of the invention;

FIG. 2 is a schematically section view of a ceramic spray-coated member according to an embodiment of the invention;

FIG. 3 is a schematic view illustrating a contact angle θ of water at an outer surface of a spray coating;

FIG. 4 is a view showing change of a contact angle θ of water in FIG. 3 with a lapse of time;

FIG. 5 is a view showing results measured on a surface of a natural-hydrophobilizaed spray coating by a High-Resolution Electron Energy Loss Spectroscopy;

FIG. 6 is a flow chart illustrating a method of producing a ceramic spray-coated member according to the invention;

FIG. 7 is a schematic view of a structure of a mini-environment for storing a ceramic spray-coated member; and

FIG. 8 is a view showing results measured on an amount of an organic matter adhered on an outer surface after a ceramic spray-coated member is stored in a space of a mini-environment for a given tire.

### BEST MODE FOR CARRYING OUT THE INVENTION

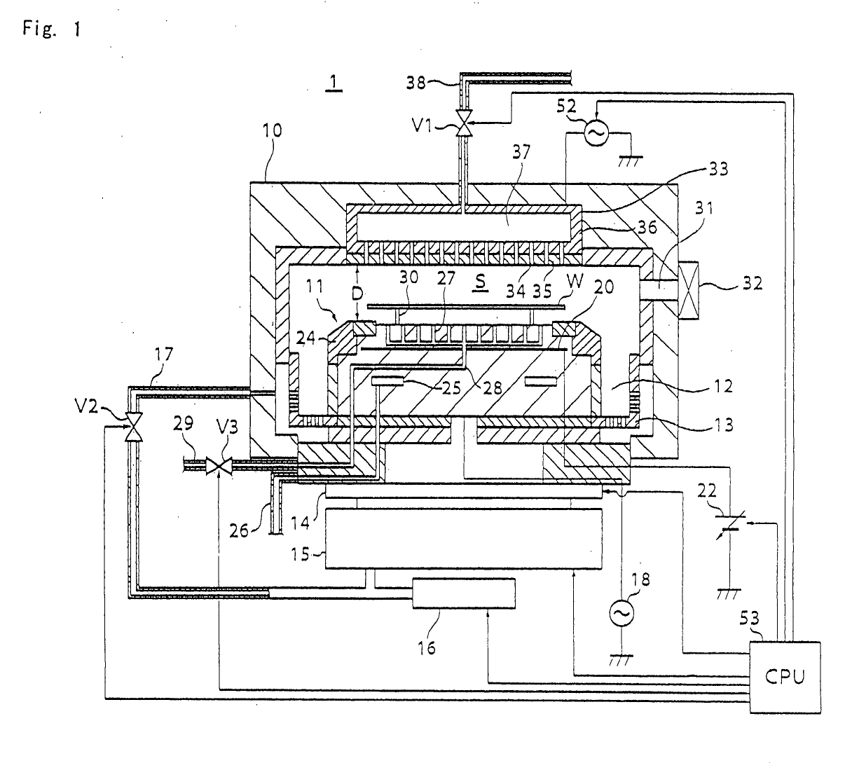

FIG. 1 shows a schematically section view of a plasma treating apparatus using a ceramic spray-coated member according to an embodiment of the invention.

In FIG. 1, the plasma treating apparatus 1 constructed as an etching apparatus for subjecting a wafer W to an etching treatment comprises a cylindrical chamber (treating chamber) 10 made of a metal such as aluminum or stainless steel. In the chamber 10 is arranged a columnar susceptor 11 as a stage of placing a wafer W having a diameter of 300 mm.

Between a side wall of the chamber 10 and the susceptor 11 is formed a discharge path 12 serving as a flow path discharging a gas above the susceptor 11 toward outside of the chamber 10. On the way of the discharge path 12 is arranged an annular baffle plate 13, and a space in the discharge path 12 at a downstream side of the baffle plate 13 is communicated with an automatic pressure control valve (hereinafter abbreviated as APC) 14 being a variable butterfly valve. The APC 14 is connected to a turbo molecule pump (hereinafter abbreviated as TMP) 15 being a vacuum discharge pump, and further connected through TMP 15 to a dry pump (hereinafter abbreviated as DP) 16 being a discharge pump. The discharge pathway constituted with APC 14, TMP 15 and DP 16 is called as “main discharge line”. This main discharge line conducts the control of the pressure in the chamber 10 through the APC 14 but also reduces the pressure inside the chamber 10 up to a vacuum state through the TMP 15 and DP 16.

Also, the space in the discharge path 12 at the downstream side of the baffle plate 13 is connected to a discharge path (hereinafter referred to as a coarse line) other than the main discharge like. This coarse line comprises a discharge pipe 17 communicating the space with the DP 16 and having a diameter of, for example, 25 mm and a valve V2 arranged on the way of the discharge pipe 17. The valve V2 can shut off between the space and the DP 16. The coarse line discharges a gas inside the chamber 10 through the DP 16.

To the susceptor 11 is connected a high frequency power source 18 applying a given high frequency power to the susceptor 11. To an upper part inside the susceptor 11 is arranged a circular electrode plate 20 made of an electrically conductive film for adsorbing the wafer W through a static adsorption force. The electrode plate 20 is electrically connected to a direct current source 22. The wafer W is adsorbed and kept on the upper face of the susceptor 11 through a coulomb force or Johnsen-Rahbek force generated by a direct current applied from the direct current source 22 to the electrode plate 20. When the wafer W is not adsorbed, it is at a floating state because the conduction of the electrode plate 20 to the direct current power source 22 is shut off. Also, an annular focus ring 24 made of silicon (Si) or the like converges a plasma generated above the susceptor 11 toward the wafer W.

An annular refrigerant chamber 25, for example, extending in a peripheral direction is arranged inside the susceptor 11. Into the refrigerant chamber 25 is circularly fed a cooling medium of a given temperature such as cooling water from a chiller unit (not shown) through a pipe 26, and the treating temperature of the wafer W is controlled above the susceptor 11 by the temperature of the cooling medium.

On a portion of the upper surface of the susceptor 11 adsorbing the wafer W (hereinafter referred to as an adsorption face) are arranged a plurality of heat-conducting gas supply holes 27 and a heat-conducting gas feed pipe (not shown). These heat-conducting gas feed holes 27 and the like are communicated with a heat-conducting gas feed pipe 29 having a valve V3 through a heat-conducting gas feed line 28 arranged inside the susceptor 11, and feed a heat-conducting gas such as He gas from a heat-conducting gas feed portion (not shown) connected to the heat-conducting gas feed pipe 29 to a space between the adsorption face and a back surface of the wafer W. Thus, a heat conductivity between the wafer W and the susceptor 11 is improved. Moreover, the valve V3 can shut the connection of the heat-conducting gas feed holes 27 and the like to the heat-conducting gas feed portion.

On the adsorption face are arranged plural pusher pins 30 as a lift pin freely projecting from the upper surface of the susceptor 11. These pusher pins 30 are moved in up and down directions in the figure by converting a rotating movement of a motor (not shown) into a linear movement through ball screws or the like. When the wafer W is adsorbed and kept on the adsorption face, the pusher pins 30 are housed in the susceptor 11. When the wafer W after the completion of the plasma treatment such as etching treatment is transported off from the chamber 10, the pusher pins 30 are projected from the upper surface of the susceptor 11 to lift up the wafer W upward from the susceptor 11.

In a ceiling portion of the chamber 10 is arranged a shower head 33. To the shower head 33 is connected a high frequency power source 52. From the high frequency power source is applied a given high frequency power to the shower head 33. Thus, the shower head 33 serves as an upper electrode.

The shower head 33 comprises a lower face electrode plate 35 having a plurality of gas vent holes 34 and an electrode support 36 detachably supporting the electrode plate 35. In an interior of the electrode support 36 is arranged a buffer chamber 37, and a pipe 38 introducing a treating gas from a treating gas feed portion (not shown) is connected to the buffer chamber 37. On the way of the treating gas pipe 38 is arranged a valve V1. The valve V1 can shut the communication of the buffer chamber 37 to the treating gas feed portion. In this case, an electrode distance D between the susceptor 11 and the shower head 33 is set within, for example, a range of 27±1 mm.

To a side wall of the chamber 10 is attached a gate valve 32 opening and closing an outlet port 31 for transporting the wafer W. In the chamber 10 of the plasma treating apparatus 1, the high frequency power is applied to the susceptor 11 and the shower head 33 as mentioned above, and a high density plasma is generated from the treating gas in the space S by the applied high frequency power to form an ion and a radial.

The plasma treating apparatus 1 is provided with CPU 53 arranged at its inside or outside. The CPU 53 is connected to the valves V1, V2, V3, the APC 14, the TMP 15, the DP 16, the high frequency power sources 18, 52 and the direct current source 22 and controls the operation of each constitutional element in accordance with user's command and predetermined process recipe.

In the plasma treating apparatus 1, the gate valve 32 is first opened in the etching treatment and the wafer W to be worked is transferred into the chamber 10 and placed on the susceptor 11. Then, the treating gas (e.g. a mixed gas of C₄F₈ gas, O₂ gas and Ar gas at a given flow rate) is introduced into the interior of the chamber 10 at a given flow amount and flow ratio through the shower head 33 and the pressure inside the chamber 10 is adjusted to a given value through the APC 14 and the like. Next, a high frequency power is applied from the high frequency power source 52 to the shower head 33, while a current voltage is applied from the direct current source 22 to the electrode plate 20 to adsorb the wafer W onto the susceptor 11. Thus, the treating gas discharged from the shower head 33 is rendered into a plasma as previously mentioned. The radical and ion generated from the plasma are converged onto the surface of the wafer W through the focus ring 24 to physically or chemically etch the surface of the wafer W.

As the treating gas in the etching treatment are used a gas containing a halogen element such as fluoride, chloride, bromide in addition to the above mixed gas, so that the interior of the chamber 10 forms a strong corrosion environment. In order to prevent the constitutional parts in the chamber from corroding under the corrosion environment, a ceramic such as yttrium oxide (Y₂O₃) (hereinafter referred to as yttria), aluminum oxide (Al₂O₃) or the like is sprayed onto the focus ring 24, shower head 33, susceptor 11, inner wall of the chamber 10 and the like. That is, all parts used in the chamber 10 and the inner wall of the chamber 10 correspond to the ceramic spray-coated members.

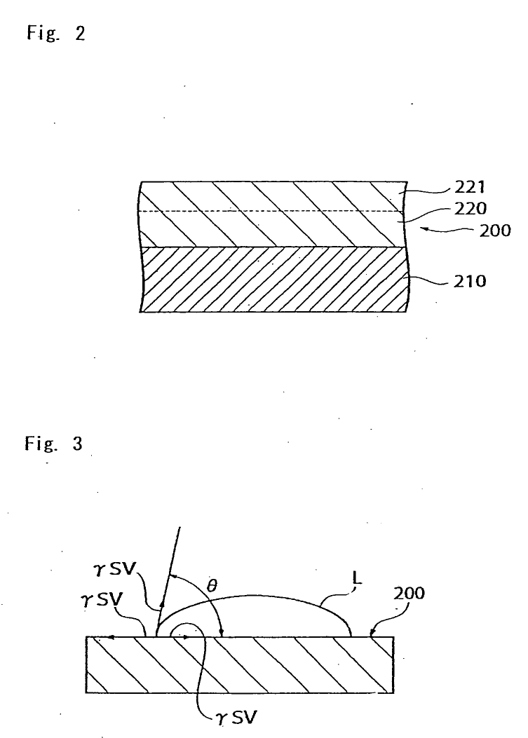

FIG. 2 is a schematically section view illustrating a structure of the ceramic spray-coated member according to the invention.

In FIG. 2, the ceramic spray-coated member 200 comprises a base material 210 and a spray coating (surface layer) 220 formed on the surface of the base material 210 by spraying. The spray coating 220 has a hydration treated later 221 composed mainly of a ceramic hydroxide on its outer surface. The spray coating 220 has a thickness of 10-500 μm, and the hydration treated layer 221 has a thickness of, for example, about 100 μm or more.

As the base material 210 are preferably used various steels including stainless steel (SUS), Al and Al alloy, W and W alloy, Ti and Ti alloy, Mo and Mo alloy, carbon and oxide, non-oxide ceramic sintered body, carbonaceous material and so on.

The spray coating 220 is made from a ceramic containing an element belonging to Group 3a in the periodic table, and it is preferable to be made from a rare earth metal oxide including an oxide of an element belonging to Group 3a in the periodic table. Among them, yttria, Sc₂O₃, CeO₂, Ce₂O₃, Nd₂O₃ are preferably used, and particularly yttria frequently used from the old time is used. Thus, there can be controlled the erosion of the ceramic spray-coated member 200 by the strong corrosion environment in the chamber 10. The spray coating 220 may be formed by a thin film forming technique such as PVD process, CVD process or the like in addition to the spraying method.

The hydration treated layer 221 is formed on the outer surface of the spray coating 220 by reacting the spray coating 220 with a steam or a high-temperature water to conduct hydration. In case of using yttria among the ceramics, the reaction shown by the following reaction formula (1) occurs on the outer surface of the spray coating 220.

Y₂O₃+H₂O→Y₂O₃.(H₂O)n→2(YOOH)→Y(OH)₃ (1)

In this case, the formula (1) does not consider the valence number.

As shown by the formula (1), the hydroxide of yttria is finally formed by the hydration treatment. Even in the other element belonging to Group 3a in the periodic table, the hydroxide is formed by substantially the same reaction. As the hydroxide are preferable Y(OH)₃, Sc(OH)₃, Ce(OH)₃, Nd(OH)₃.

Since the hydroxide of the element belonging to Group 3a in the periodic table is very stable and indicates a characteristic of suppressing the detachment of chemically adsorbed water and controlling the adsorption of water from exterior (hydrophobicity), when the hydration treated layer 221 composed mainly of the above hydroxide is formed on the outer surface of the spray coating 220 by the hydration treatment, the detachment of water and adhesion of water from exterior in the ceramic spray-coated member 200 can be suppressed.

In order to form the uniform hydration treated layer 221 on the spray coating 220 of the ceramic spray-coated member 200, it is required that the outer surface of the spray coating 220 has a hydrophilicity in the hydration treatment of the spray coating 220. When a contact angle θ of water L on the outer surface of the spray coating 220 is measured by a method shown in FIG. 3, the contact angle θ of water on the outer surface of the spray coating 220 just after the spraying on the ceramic spray-coated member is 0 degree, while the contact angle θ of water on the outer surface of the spray coating 220 left to stand in air for several days is about 30 degrees. That is, the spray coating 220 just after the spraying shows the hydrophilicity, but when the spray coating 220 is exposed to air, the outer surface of the spray coating 220 is hydrophobilized to make the contact angle θ large. This phenomenon is called as a natural hydrophobilization phenomenon.

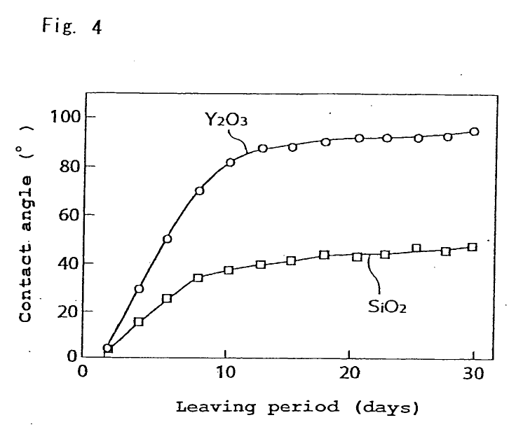

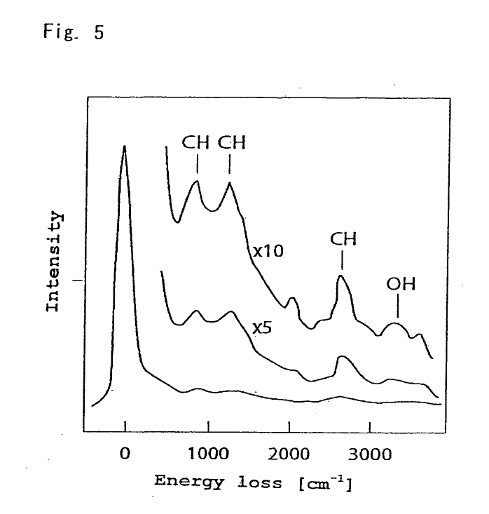

Concretely, when the ceramic spray-coated member provided with the spray coating 220 of yttria is left to stand in air having a temperature of 20-25° C. and a humidity of 50-60% and the ceramic spray-coated member provided with the spray coating of SiO₂ is left to stand in air having a temperature of 20-25° C. and a humidity of 50-60%, the contact angle θ increases with a lapse of predetermined days as shown in FIG. 4.

When the surface of the spray coating 220 made of natural hydrophobilized yttria is measured by a High Resolution Electron Energy Loss Spectroscopy, as shown in FIG. 5, peaks are existent at positions of 1050/cm, 1500/cm, 2960/cm and 3600/cm, respectively, in addition to elastic scattering peak (energy loss=0). They are absorption peaks based on vibration mode of molecule adsorbed on the surface, which are identified to CH bending vibration (1050/cm, 1500/cm), CH stretching vibration (2960/cm) and OH stretching vibration (3600/cm), respectively, so that the organic matter having a CH group or a hydrocarbon group adheres to the surface of the natural hydrophobilized yttria.

From the above, it is clear that the natural hydrophobilization phenomenon is related to the adhesion of the organic matter to the spray coating. That is, it is considered that the surface of the spray coating is natural-hydrophobilized by adhering the organic matter to the surface. As the surface is natural-hydrophobilized, the spray coating 220 does not pull water molecule, so that the hydration reaction on the surface of yttria does not proceed. In order to surely conduct the hydration treatment of the spray coating 220, therefore, it is required to prevent the adhesion of the organic matter to the surface of yttria by removing the organic matter adhered to the surface of yttria or leaving to stand in air, or the like.

Next, there is explained the production method of the ceramic spray-coated member 200 having the above construction.

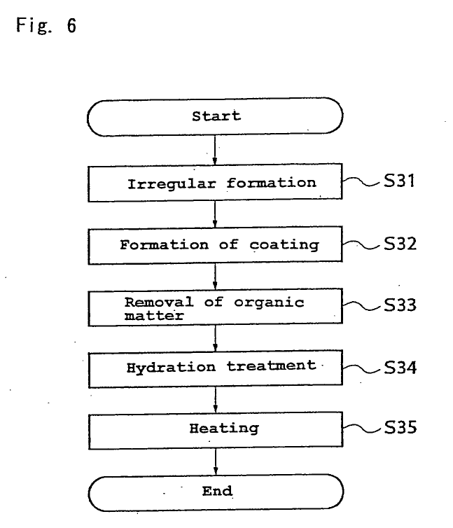

FIG. 6 is a flow chart illustrating the production method of the ceramic spray-coated member according to the invention. The production method of the ceramic spray-coated member is described using the case that the spray coating is made from yttria below.

In FIG. 6, the surface of the base material 210 is first subjected to a blast treatment of blowing particles of Al₂O₃, SiC, silica or the like to form fine irregularities on the surface of the base material 210 (step S31). Then, yttria is sprayed on the surface of the base material 210 having fine irregularities to form the spray coating 220 (step S32).

Next, the ceramic spray-coated member 200 is immersed in an organic solvent including at least one of acetone, ethyl alcohol, methyl alcohol, butyl alcohol and isopropyl alcohol for a predetermined time to remove the organic matter adhered to the spray coating 220 (removal step) (step S33). Since the organic matter is easily dissolved in the organic solvent, the organic matter having a hydrocarbon group mainly causing the obstruction of hydration reaction at the ceramic surface elutes into the organic solvent. Thus, the organic matter is removed off from the surface of the spray coating 220 to render the surface into a non-detected state.

Thereafter, the ceramic spray-coated member 200 is heated to a temperature of about 100-300° C. for 1-24 hours under an environment that a pressure is not less than 202.65 kPa (2.0 atm) and a relative humidity is not less than 90%. That is, the ceramic spray-coated member 200 is exposed to the environment of high pressure, high humidity and high temperature to hydrate the outer surface of the spray coating 200 (stabilization step)(step S34). Thus, the hydration treated layer 221 is formed on the outer surface of the spray coating 220. In the hydration treated layer 221, yttria progressing the hydration reaction is stabilized by chemically bonding to water, whereby the adhesion and detachment of water can be controlled in the vicinity of the temperature inside the chamber conducting the process.

Moreover, if the relative humidity and the heat treating temperature are low, it is sufficient to make the heating time of the base material 210 long. In order to efficiently conduct the hydration reaction, it is required to conduct the hydration treatment under high temperature and high pressure environments. However, the hydration reaction on the surface of yttria can be sufficiently progressed, for example, by conducting at about room temperature over a long time, so that it is possible to subject the outer surface of the spray coating 220 to the hydration treatment under conditions other than the above environment.

Then, the ceramic spray-coated member 200 provided with the hydration treated layer 221 is heated at a temperature of at least not lower than 70° C., preferably about 100° C. in a drying furnace under a pressure of 101.3 kPa (1.0 atm) for not less than about 2 hours to dry water adhered to the hydration treated layer 221 or the spray coating 220 (step S35). Thus, water trapped in fine pores on the surface of the hydration treated layer 221 or water physically adsorbed on the hydration treated layer 221 is detached. Further, the inside of the drying furnace is purged with a gas having a high reactivity with water to complete the treatment.

According to this embodiment, the organic matter adsorbed on the surface of the ceramic spray-coated member 200 is removed (step S33) and the surface of the ceramic spray-coated member is stabilized by chemically bonding to water (step S34), so that the hydration reaction at the ceramic surface is promoted when the ceramic spray-coated member 200 is subjected to the hydration treatment and the hydrophobicity can be sufficiently obtained on the surface of the spray coating, and hence the adhesion and detachment of water can be surely controlled in the use of the ceramic spray-coated member 200.

In this embodiment, the ceramic spray-coated member 200 is immersed in the organic solvent such as acetone, ethyl alcohol, isopropyl alcohol or the like for a predetermined time, but it is not limited thereto. The ceramic spray-coated member 200 may be immersed in an acid for a given time. In the latter case, the outer surface of the spray coating 220 adhered with the organic matter can be etched to remove the organic matter from the outer surface of the spray coating 220. The acid is preferable to include at least one of hydrofluoric acid, nitric acid, hydrochloric acid, sulfuric acid and acetic acid.

In the above embodiment, the organic matter adhered to the spray coating 220 is removed by immersing the ceramic spray-coated member 200 in the organic solvent such as acetone, ethyl alcohol, methyl alcohol, butyl alcohol or isopropyl alcohol for the predetermined time after the spray coating 220 made of yttria is formed on the surface of the base material 210, but it is not limited thereto. The outer surface of the spray coating 220 may be subjected to the hydration treatment immediately after the spray coating 220 made of yttria is formed on the surface of the base material 210. That is, the outer surface of the spray coating 220 may be subjected to the hydration treatment before the adhesion of the organic matter to the outer surface of yttria. As shown in FIG. 4, the contact angle θ increases from one day after the leaving, so that the outer surface of the spray coating 220 may be subjected to the hydration treatment within one day after the spray coating 220 made of yttria is formed on the surface of the base material 210.

Moreover, if the outer surface of the spray coating 220 can not be subjected to the hydration treatment within 24 hours after the spray coating 220 made of yttria is formed on the surface of the base material 210, the ceramic spray-coated member 200 after the formation of the spray coating 220 on the surface of the base material 210 is stored under a locally clean environment such as mini-environment mentioned later or the like for preventing the adsorption of the organic matter onto the surface of the ceramic spray-coated member 200 and thereafter water chemically adsorbed on the surface of the ceramic spray-coated member 200 may be stabilized by bonding. In this way, the natural hydrophobilization on the surface of the spray coating 220 is suppressed, and hence when the ceramic spray-coated member 200 is subjected to the hydration treatment, the hydration reaction on the surface of the spray coating 220 can be promoted to sufficiently provide the hydrophobicity at the surface of the spray coating 220 and the adhesion and detachment of water in the ceramic spray-coated member 200 can be surely controlled.

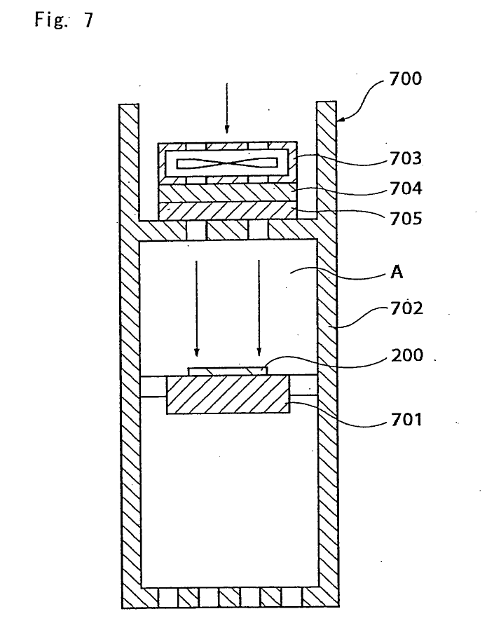

FIG. 7 is a view showing a structure of a mini-environment for storing the ceramic spray-coated member 200.

In FIG. 7, the mini-environment 700 has a box-like structure generating a unidirectional flow in an interior and comprises a vessel 702 having a predetermined space A and provided with a support base 701 capable of supporting the ceramic spray-coated member 200 in the space A, a fan 703 arranged on an upper part of the vessel 702 and introducing air into the space A, a chemical filter 704 removing the organic matter from air introduced into the space A with an activated carbon or the like, and a particle-removing filter 705 removing fine particles floating in air and the like.

The space A inside the mini-environment 700 is always kept at a cleaned state because the organic matter is removed from air introduced into the space A through the fan 703 with the chemical filter 704. Therefore, when the ceramic spray-coated member 200 having the spray coating 220 of yttria is stored in the space A of the mini-environment 700, the exposure of the spray coating 220 to air can be prevented and hence the adhesion of the organic matter onto the surface of the spray coating 220 can be prevented.

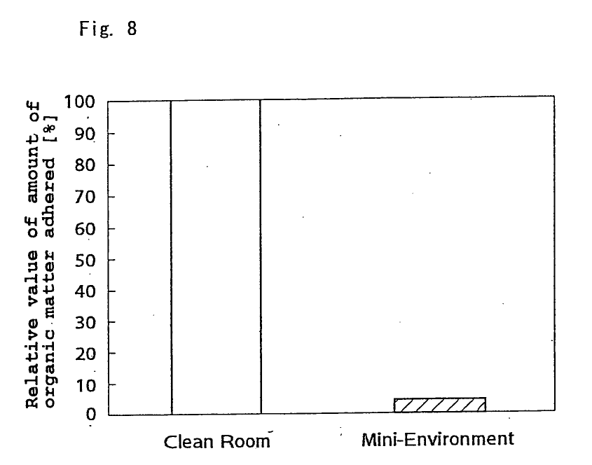

In FIG. 8 are shown results when the amount of the organic matter adhered to the outer surface is measured after the ceramic spray-coated member 200 is stored in the space A of the mini-environment for a given time. As a comparative example, this figure also shows the value when the amount of the organic matter adhered to the outer surface is measured after the ceramic spray-coated member 200 is stored in a general clean room atmosphere for the same time. As seen from FIG. 8, the amount of the organic matter adhered to the outer surface of the ceramic spray-coated member 200 stored in the mini-environment 700 is reduced to about 5% as compared with the amount of the organic matter adhered to the outer surface of the ceramic spray-coated member 200 stored in the general clean room atmosphere for the same time.

In the above embodiment, the hydration treatment of step S34 is carried out by exposing the ceramic spray-coated member 200 to the environment of high pressure, high humidity and high temperature, but it is not limited thereto. It may be carried out by immersing the ceramic spray-coated member 200 in a boiling water.

As the production method of the ceramic spray-coated member, the organic matter adsorbed on the surface of the ceramic spray-coated member 200 is removed and the surface of the ceramic spray-coated member is stabilized by chemically bonding to water before the use in the plasma treating apparatus 1 but it is not limited thereto. The production method according to the invention is applicable to the ceramic spray-coated member during the use, for example, the cleaning of the ceramic spray-coated member taken out for maintenance after the predetermined time of the etching treatment in the plasma treating apparatus 1.

Since the ceramic spray-coated member 200 according to the invention passes through the organic matter removing treatment of step S33 and the hydration treatment of step S34, the hydration treated layer 221 contains a hydroxide of a ceramic and the organic matter having the hydrocarbon group is removed from the surface thereof. As a method of judging whether or not the constitutional parts in the chamber are treated through the production method according to the invention, therefore, it is preferable to use the high resolution electron energy loss spectroscopy for detecting the hydroxyl group on the surfaces of the constitutional parts. When the hydroxyl group is detected and the hydrocarbon group is not detected on the surfaces of the constitutional parts by this spectroscopy, these constitutional parts can be judged to be produced by the production method according to the invention.

Moreover, the ceramic spray-coated member 200 in the above embodiment is a part used in the chamber 10 of the plasma treating apparatus 1, but it is not limited thereto. It may be used in a process apparatus other than the plasma treating apparatus, or in a transporting apparatus such as a road lock chamber transferring the substrate or the like into the process apparatus, an atmosphere transferring module or the like.

In the above embodiment, a material to be treated in the plasma treating apparatus 1 is the wafer W, but it is not limited thereto. For example, there may be glass substrates such as FPD (flat panel display) including LCD (liquid crystal display) and the like.

As to the production method of the ceramic spray-coated member according to the invention, a control part for controlling an operation of each constitutional part in a production system of the ceramic spray-coated member comprising, for example, the blast treating apparatus, yttria spraying apparatus, heat treating furnace under a pressure, drying furnace, and immersion apparatus or mini-environment, for example, a computer provided on the production system may conduct the above production method.

Also, the object of the invention is attained by supplying the storage medium recoding a program code of a software for realizing the function of the above embodiment to the production system and reading out the program code recorded in the storage medium by means of the computer in this system (or CPU, MPU or the like).

In this case, the program code itself read out from the storage medium realizes the novel function of the invention, so that the program code, storage medium recoding the program code and the program itself constitute the invention.

As the storage medium for supplying the program code can be used, for example, a floppy disc (Registered trade mark), a hard disc, an optical disc, an optomagnetic disc, CD-ROM, CD-R, CD-RW, DVD-ROM, DVD-RAM, DVD-RW, DVD+RW, a magnetic tape, a non-volatile memory card, ROM and the like. Alternatively, the above program is supplied by down-loading from the other computer or data base (not shown) connected to an internet, commercial network, local area network or the like.

Also, the function of the above embodiment is realized by conducting the program code read out by the computer but also OS (operating system) or the like worked in the computer conducts a part or a whole of the actual treatments based on the indication of the program code, whereby the function of the above embodiment may be realized.

Further, the program code read out from the storage medium is written into a function enhanced board inserted into the computer or a memory in a function enhancement unit connected to the computer and then a part or a whole of the actual treatments are carried out by the function enhanced card or CPU or the like in the function enhancement unit based on the indication of the program cord, whereby the function of the above embodiment may be realized.

What is claimed:

1. A method of producing a ceramic spray-coated member by spraying a given ceramic onto a surface of a base material, which comprises the steps of removing an organic matter adsorbed on a surface of the ceramic spray-coated member and chemically bonding the surface of the ceramic spray-coated member to water to conduct stabilization thereof.

2. The method according to claim 1, wherein the removing step is conducted by immersing the ceramic spray-coated member in an organic solvent.

3. The method according to claim 2, wherein the organic solvent includes at least one of acetone, ethyl alcohol, methyl alcohol, butyl alcohol and isopropyl alcohol.

4. The method according to claim 1, wherein the removing step is conducted by immersing the ceramic spray-coated member in an acid.

5. The method according to claim 4, wherein the acid includes at least one of hydrofluoric acid, nitric acid, hydrochloric acid, sulfuric acid and acetic acid.

6. The method according to claim 1, wherein the organic matter has a hydrocarbon group containing at least CH group.

7. The method according to claim 1, wherein the ceramic is made of a rare earth metal oxide.

8. The method according to claim 7, wherein the rare earth metal oxide is yttria.

9. The method according to claim 1, wherein the ceramic spray-coated member is used in a chamber for treating a substrate.

10. A method of producing a ceramic spray-coated member by spraying a given ceramic onto a surface of a base material, which comprises the steps of preventing adsorption of an organic matter onto a surface of the ceramic spray-coated member and chemically bonding the surface of the ceramic spray-coated member to water to conduct stabilization thereof.

11. The method according to claim 10, wherein the adsorption preventing step is conducted by storing the ceramic spray-coated member in a flow of a gas passed through a chemical filter.

12. The method according to claim 10, wherein the organic matter has a hydrocarbon group containing at least CH group.

13. The method according to claim 10, wherein the ceramic is made of a rare earth metal oxide.

14. The method according to claim 13, wherein the rare earth metal oxide is yttria.

15. The method according to claim 10, wherein the ceramic spray-coated member is used in a chamber for treating a substrate.

16. A storage medium for housing a readable program for conducting a method of producing a ceramic spray-coated member by spraying a given ceramic on a surface with a computer, characterized in that the program has a removal module for removing an organic matter adsorbed on the surface of the ceramic spray-coated member and a stabilization module for chemically bonding the surface of the ceramic spray-coated member to water to conduct stabilization.

17. A storage medium according to claim 16, wherein the removal module is an immersion of the ceramic spray-coated member in an organic solvent.

18. A storage medium according to claim 16, wherein the removal module is the immersion of the ceramic spray-coated member in an acid.

19. A storage medium for housing a readable program for conducting a method of producing a ceramic spray-coated member by spraying a given ceramic on a surface with a computer, characterized in that the program has an adsorption preventing module for preventing adsorption of an organic matter on the surface of the ceramic spray-coated member and a stabilization module for chemically bonding the surface of the ceramic spray-coated member to water to conduct stabilization.

20. A storage medium according to claim 19, wherein the adsorption preventing module is the storage of the ceramic spray-coated member in a flow of a gas passed through a chemical filter.
